(19) United States
(12) Patent Application Publication
(10) Pub. No.: US 2017/0276458 A1
(43) Pub. Date: Sep. 28, 2017

(54) Living camouflage achieved from a substantially transparent substrate having an array of micro-lenses on one side and a colorized patterns opposite, where the lens array interacts with the patterns to exhibit color and or form change when viewed at differing angles, and a method of manufacture same

(71) Applicants: Joel Scott Scarbrough, Lindenhurst, IL (US); David Eric Roberts, Avoca, WV (US)

(72) Inventors: Joel Scott Scarbrough, Lindenhurst, IL (US); David Eric Roberts, Avoca, WV (US)

(21) Appl. No.: 15/078,218

(22) Filed: Mar. 23, 2016

(51) Int. Cl. F41H 3/00; G02B 3/00; G02B 5/02; B41M 3/00

(52) U.S. Cl. CPC F41H 3/00; B41M 3/003; G02B 3/0056; G02B 5/0252; G02B 3/0031

(57) ABSTRACT

An optical system providing a “living camo”, a color and form changing camouflage achieved from a substantially planar transparent base film substrate having a first side and a second side, with the first side having an optical surface composed of an array of optical micro-lenses, and with the second side having a colorized camouflage pattern, such that the lens array on the first side interacts with the colorized camouflage pattern on the second side to exhibit a color and or form change when viewed from the first side at differing angles, and a method of manufacture same.

### FIELD OF THE INVENTION

The present subject matter generally relates to the field of tactical and hunting camouflage, concealment, and deception of objects, hardware, as-sets and personnel. More particularly, the present subject matter relates to thin, visually active, optical camouflage material, that changes color and form when viewed from varying angles, that is intended for camouflage, concealment, and deception use in hunting, field training, combat and surveillance operations.

### BACKGROUND OF THE INVENTION

Camouflage is the use of any combination of materials, coloration, or illumination for concealment, either by making animals or objects hard to see (“crypsis”), or by disguising them as something else (“mimesis”). Examples include the leopard's spotted coat, the battledress of a modern soldier, and the leaf-mimicking of a katydid's wings. A third approach, motion dazzle, confuses the observer with a conspicuous pattern, making the object visible but momentarily harder to locate. The majority of camouflage methods aim for crypsis, often through a general resemblance to the background, high contrast disruptive coloration, eliminating shadow, and countershading.

The use of man made camouflage materials is well understood: it is used to hide individuals and their equipment from an enemy, or animals. Generally, camouflage material is colored with dull hues that match the predominant colors of the surrounding environment. Contrary to popular belief, camouflage does not work by making the wearer or object invisible. Rather, it works by creating visual confusion and thereby disguises a recognizable form by breaking up its outline. The reason for using camouflage is that it is visually disruptive. The meandering lines of a mottled camouflage pattern help hide the contour, or outline, of the body. When looking at a piece of mottled camouflage in a matching environment, the brain naturally “connects” the lines of the colored blotches with the lines of the trees, ground, leaves and shadows. This affects the way a person perceives and recognizes the individual or object hidden by camouflage.

Human perception naturally categorizes things in the world as separate objects. When a person looks at a scene, the person is gathering an immense amount of information with their eyes and other senses. In order for the person's conscious mind to make any sense out of this information, the person's brain has to break it down into component parts. When the brain perceives a long, vertical area of brown with green blotches connected to it, the person perceives a tree. Further, when the brain perceives many, many individual trees in a given area, the person perceives a forest.

In nature, animals, insects, fish, and birds are disguised and sometimes resort to false behavior to mislead their enemies in defense, and their prey in offense. Among animals, when the object to be imitated is normally motionless, the disguised creature also remains that way, thereby achieving some advantage such as food or safety. If the object copied is one which is usually in motion, for example weeds or leaves drifting in water, the animal imitates these movements with great exactness.

In an outdoor environment, the surroundings move and change form both from wind and when the viewing angle or direction is changed. Prior art camouflage materials are printed, static, and do not change colors or form when viewed from different angles, as opposed to nature's animated or “living” environment. Thus prior art static camouflage generally differs from the immediate animated surrounding, compromising or lessening the camouflage effect.

Accordingly, a camouflage material that was animated or “living”, that changed colors and/or form when viewed from different angles would be of great benefit to the industry and could accurately be described as “living camo”.

### OBJECT OF THE INVENTION

It is an object of the presently disclosed subject matter to provide a heretofore demanded but unsatisfied improvement to the function of camouflage, by adding functional color and form changing to camouflage material and disclosing methods for making the same. This color and form changing camouflage material is useful as a more realistic and natural way to blend into the surrounding natural environment, and is therefore a significant value for hunters, photographers, and military personnel to assist in preventing visible detection from animals or enemy personnel.

While there have been significant advances in lenticular lens array optical effects over the past 50 years; from trinkets which change imagery when tilted, to the micro-optical security thread found in some of today's currency, none of these have been developed specifically to perform for camouflage applications. It has been our objective to utilize the latest capabilities and advancements in micro-lens array technology and wavelength bending characteristics of such lens arrays specifically and optimally for camouflage applications and to develop a superior living camo material with superior performance characteristics.

Another object is to provide a material that can be adhered, using a variety of adhesive types, sewn, fitted, or generally attached to a variety of objects, including but not limited to; Hunting Blinds, Deer Stands, Duck Blinds, Vehicle Wrap, Aircraft exterior, Outdoor Building/Construction Panels, Backpacks, Outdoorsman Clothing, Cameras and Components, Firearms and Components, Boat Exteriors, Foot ware, Eye ware, Helmets, Bullet Proof Vests, Tents, Targets, Coolers, Walls, furniture, and other objects related to indoor and outdoor laser tag, air soft, paint ball, and similar games, and more.

These and other aspects, objects, and features of the present invention will become apparent from the following detailed description of the invention, read in conjunction with, and reference to, the accompanying drawings.

### BRIEF DESCRIPTION OF THE DRAWINGS

FIG. 1 is a side elevation of one embodiment of the invention

FIG. 2 is a side elevation of another embodiment of the invention.

FIG. 3 is a perspective view of one embodiment of the invention.

FIG. 4 is a perspective view of a one way see-through embodiment of the invention.

### DETAILED DESCRIPTION OF THE DRAWINGS

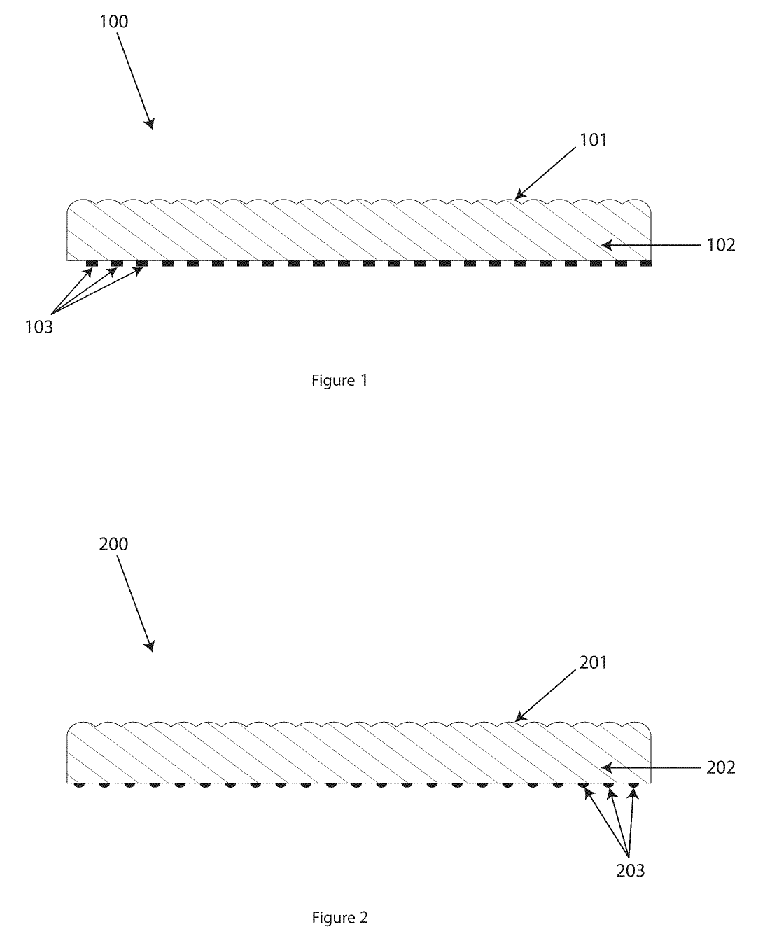

FIG. 1 is an example of one embodiment of the disclosure: a living camo material (100) consisting essentially of a substantially transparent substrate (102), having a first surface containing an array of lenses (101) formed thereon, and a pattern (103) formed on the opposite or second surface, the lenses having a focal length within plus or minus fifty percent of the thickness of the substrate, and the patterns being of a frequency and positioning relative to the positioning and frequency of the lens array, such that when viewed from the first surface and the viewing angle changes, the lenses and patterns present a synthetic image that changes colors as the viewing angle changes, and/or the left eye and right eye perceive different synthetic images which provides for the illusion of depth, motion and/or form changing.

FIG. 2 shows another embodiment of the disclosure: a living camo material (200) consisting essentially of a substantially transparent substrate (202), having a first surface containing an array of lenses (201) formed thereon, and a pattern (203) printed on the opposite or second surface, the lenses having a focal length within plus or minus fifty percent of the thickness of the substrate and the patterns being of a frequency and positioning relative to the positioning and frequency of the lens array, such that when viewed from the first surface and the viewing angle changes, the lenses and patterns present a synthetic image that changes colors as the viewing angle changes, and/or the left eye and right eye perceive different synthetic images which provides for the illusion of depth, motion and/or form changing.

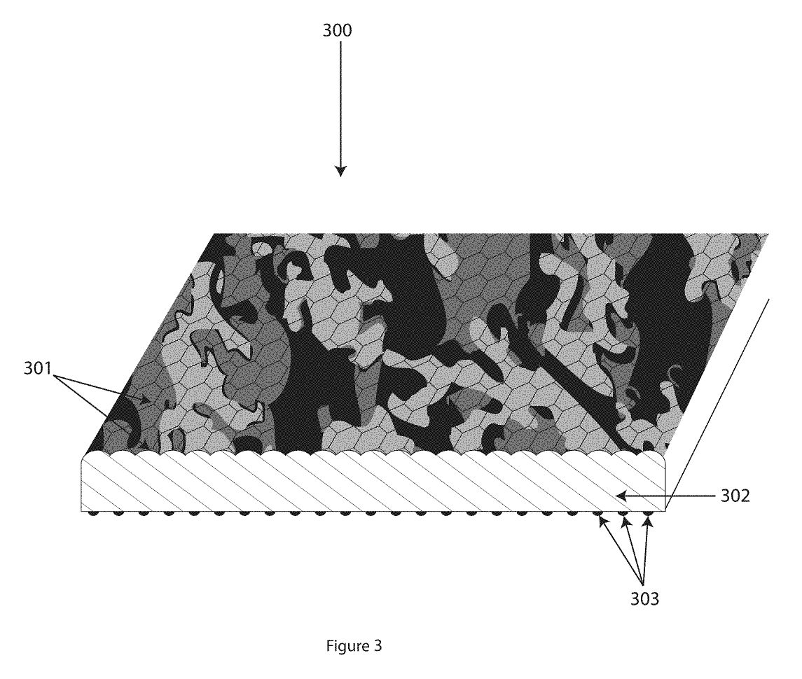

FIG. 3 shows another embodiment of the disclosure: a living camo material (300) consisting essentially of a substantially transparent substrate (302), having a first surface containing an array of hexagonal arranged substantially semi-spherical lenses (301) formed thereon, and a pattern (303) formed on the opposite or second surface, the lenses having a focal length within fifty percent of the thickness of the substrate and the patterns being of a frequency and positioning relative to the positioning and frequency of the lens array, such that when viewed from the first surface and the viewing angle changes, the lenses and patterns present a synthetic image consisting of small areas showing two or more colors, where each region of one color changes to the other color as the viewing angle changes, and/or the left eye and right eye perceive different synthetic images which provides for the illusion of depth, motion and/or form changing.

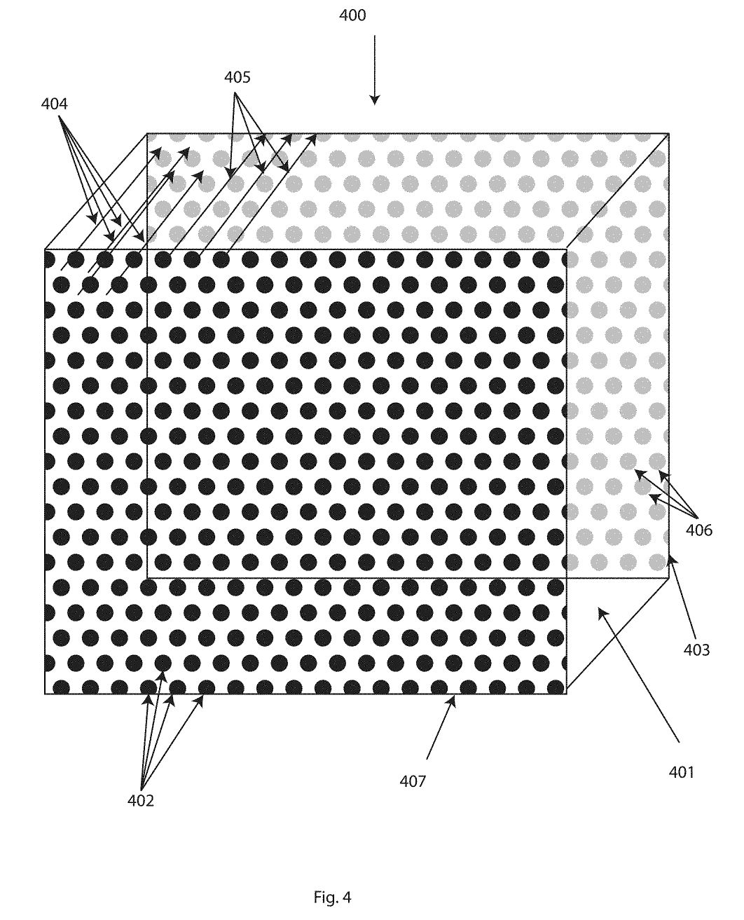

FIG. 4 shows another embodiment of the disclosure: a one way see-through living camo material (400) consistent essentially of a substantially transparent substrate (401) with a lens array, where each lens is spaced apart from its nearest neighbor by at least the diameter of each lens (403) on a first surface (403) and a pattern of colors on a second surface (402), where each patterned area only is subsequently covered with an opaque solid color, to prevent visibility of the colorized pattern when viewed through this second surface, and is in alignment with the spaced apart lenses (404) such that the visibility through the second surface is substantially unimpaired by patterns or lenses (405), and when viewed through the first surface (403) and the viewing angle changes, the patterns of colors are in a frequency and alignment with the lens frequency and alignment, such that the lenses and patterns present a synthetic image that changes colors as the viewing angle changes, and/or the left eye and right eye perceive different synthetic images which provides for the illusion of depth, motion and/or form changing, and the non-lens area being generally darker than the synthetic image allows for seeing the living camo effect when viewed from outside (first surface), while those inside (viewing through the second surface) to see outside, substantially unimpaired (i.e. similar to common see-through window film graphics used in vehicles and retail store windows where viewing through the second surface, from the inside of a car or store allows seeing outside, through a partially opaque and partially see-through film, and when viewing from outside, you see primarily the advertising graphics and not inside the car or store).

### SUMMARY OF THE INVENTION

Generally, the present invention is directed to an optical lens array based functional or living camo material that changes in color and form when seen from differing angles or depth, dimension and/or motion when seeing different synthetic images in the left and right eye. More particularly, the material is comprised of a substantially planar transparent base layer film with a lens array formed onto at least a substantial portion of the viewing surface of the base layer film, and colorized patterns that are printed or formed onto the reverse surface of the base layer, wherein the colorized patterns are arranged in a frequency and alignment with the lens array such that when viewing the material through the lens array side the material will appear to change colors in different areas and/or form as viewing angle changes, and/or depth, dimension, and/or motion when the left and right eye perceive different synthetic images. For a basic example, areas showing predominantly color A change to predominantly color B, and adjacent areas showing predominantly color B change to color A.

The base film substrate of the material can be made of any effectively transparent polymeric material, in a single layer construction, or made with multiple layers yielding improved performance for specific end-use applications. The optical surface of the first side of the base film substrate is composed of a array of convex refractive, diffractive, or fresnel lenses, for example with round, hexagonal, square, or cylindrical boundaries, that can be arranged in any number of optional arrangements, including linear packing, hexagonal packing and square packing, where the lenses in the array on the first side focus at a distance within plus or minus fifty percent of the thickness of the base film substrate, ideally near the thickness of the base film substrate, so as to substantially generate synthetic images, which images are seen being dependent on the alignment of the lens array with the patterns. The lenses are so designed to interact with the colorized pattern on the second side so as to present color and/or form changing synthetic imagery when viewed from the first side when a viewer changes position relative to the base film substrate, and/or incorporate a perception of depth resulting from different synthetic images visible from the left eye than is visible from the right eye. This interaction is accomplished by repeating small patterns of differing colors and/or form that are of a different frequency than the lenses in the array. The lenses collectively sample different colors and/or form depending on what angle one looks through the lenses to the patterns and generate a synthetic averaged image, this image being different for different viewing angles and/or the left and right eye.

According to one aspect of the invention, said lens array has a refractive index induced wavelength bending characteristic such that said lens array bends oncoming wavelengths of energy between 100 nanometers and 2000 nanometers onto the reflecting surface of the second surface of the substrate, which is reflected back at a different angle than the angle of incidence. Only wavelengths in this range whose angle of incidence is substantially perpendicular to the planar surface of the second surface of the substrate are directed back towards the source of that wavelength, effectively scattering the majority of wave-lengths and providing substantially less visibility to sight and digital detection. This adds a further non-static or “living” element to the camouflage.

According to another aspect of the invention, the material is made to be a one way see-through color and/or form changing camouflage material, wherein the lens array contains lenses where each lens is spaced apart by at least the diameter of each lens, the patterns of colors are backed with opaque shapes substantially equivalent to the area of the lenses, and are spaced apart by at least the diameter of the lenses, and registered precisely in position on the second surface of the substrate to match the position and frequency of the spaced apart lenses, so the material is effectively transparent looking through the second surface, but the color and form changing effects are not substantially impaired when viewed from the front side. (Similar to current see-through films used in advertising in store windows, on bus windows, and automobile windows.)

According to another aspect of the invention the number of color changes, or form changes are more than two changes. For example, areas showing predominantly color A change to predominantly color B, then change to predominantly color C, and so on. This is useful for complex camouflage patterns.

According to another aspect of the invention, the living camo is used in the field by hunters, photographers, and military personnel to assist in preventing visible detection.

According to another aspect of the invention, an adhesive layer is added to the non-lens side of the material to enable bonding to vehicle surfaces, aircraft, firearms, hunting blinds, and/or hunting equipment.

According to another aspect of the invention, a transparent adhesive layer is added to the reverse side of the material to enable bonding to windows.

According to another aspect of the invention, the base layer of the material itself is a window on a vehicle, aircraft, and/or hunting blind.

According to another aspect of the invention, the base layer of the material is modified to block the absorption of UV light through the addition of UV inhibitors into the material resin, improving its outdoor longevity.

According to another aspect of the invention, the base layer of the material is a modified polyolefin containing ultraviolet inhibitors and ultraviolet blockers.

According to another aspect of the invention, the surface of the lens array side of the material has a microscopic surface roughness reducing gloss and or sheen from reflecting light. Further, the optical surface of the base film substrate material can structurally modified or coated to reduce reflection of light, which would be important in blending into certain environments.

According to another aspect of the invention, the lens array surface of the material has a microscopic surface roughness reducing gloss and or sheen, and the base layer consists of polymers with inherent outdoor weather resistance, such as acrylic polymers.

According to another aspect of the invention, the base layer of the material consists of polymers with inherent flexibility for adhering or conforming to compound curved surfaces.

According to another aspect of the invention, a living camo where the substantially transparent substrate is produced from a highly engineered plastic to add performance characteristics to the living camo such as bullet penetration protection and/or shatter protection.

According to another aspect of the invention, a living camo where the material is stitched on adhered to fabric, cloth or other material worn as clothing, converted into tents, or other similar applications.

According to another aspect of the invention, a living camo where the lenses within the lens array side of the material have a common focal length between 20 and 400 microns.

According to another aspect of the invention, lens array within the lens array side of the material has a melting point higher than an in-mold labeling process, such that when placed into a mold cavity and resin is injected onto the non-lens side of the base layer of the material, the base layer will bond to said resin and lens array will not melt and therefore continue to function and reveal color and/or form changing effects.

According to another aspect of the invention, a method of producing the material comprising:
1. Printing or forming a substantially planar transparent base layer film with a lens array onto at least a substantial portion of the viewing surface of said base layer film
2. Forming or printing colorized patterns onto the reverse surface of said base layer.
3. Placing the lenses and the colorized patterns in such an alignment with each other, so when viewed through lens array at different angles, synthetic images are formed such that changes in color and/or form are seen or changes in form are observed, and/or depth is perceived because the synthetic images are different for the left and right eye.

According to another aspect of the invention, a method of producing the material comprising:
1. Printing or forming a substantially planar transparent base layer film with a lens array onto at least a substantial portion of the viewing surface of said base layer film
2. Forming or printing colorized patterns onto the reverse surface of said base layer.
3. The lenses and the colorized patterns are formed in alignment with each other, so when viewed through side lens array at different angles, changes in color and form are seen or changes in form are observed, and/or depth is perceived because the synthetic images are different for the left and right eye.
4. Building this construction to result in the thickness of the base layer being between 20 and 400 microns.

According to another aspect of the invention, a method of producing a one way see-through camouflage material comprising:
1. Printing or forming a substantially planar transparent base layer film with a lens array onto at least a substantial portion of the viewing surface of said base layer film, wherein the lenses are spaced apart from each nearest neighbor lens by at least the diameter of each lens.
2. Forming or printing colorized patterns onto the reverse surface of said base layer, wherein each colorized pattern, corresponding to each lens, is spaced apart from its nearest neighbor by at least the diameter of each lens.
3. Applying an opaque feature of substantially similar size as each lens over only the top of each colorized pattern region, such that visibility through the non-lens surface of the living camo is substantially unimpaired.
4. Placing the lenses and the colorized patterns in such an alignment with each other, so when viewed through lens array at different angles, synthetic images are formed such that changes in color and/or form are seen or changes in form are observed, and/or depth is perceived because the synthetic images are different for the left and right eye, when viewed through the lens array.

In describing the embodiments of the invention illustrated in figures, specific terminology is used for the sake of clarity. However, the invention is not limited to the specific terms so selected, and each specific term at least includes all technical and functional equivalents that operate in a similar manner to accomplish a similar purpose.

The exemplary embodiments are only selected samples of the solutions available by combining the teachings referenced above. The solutions necessarily are not exhaustively described herein, but are fairly within the understanding of an artisan given the foregoing disclosure and familiarity with cited art. While the preferred and alternate embodiments of the invention have been described in detail, modifications may be made thereto, without departing from the spirit and scope of the invention as delineated in the following claims.

We claim:

1. A functional color changing camouflage material comprising:
a substantially planar transparent base layer film with a lens array formed onto a substantial portion of a first surface of said base layer film, and
colorized patterns printed or formed onto the second surface of said base layer,
wherein said colorized patterns are in frequency and alignment with said lens array such that when viewed through said first surface and viewing angle changes, areas showing predominantly color A change to predominantly color B, and areas showing predominantly color B change to predominantly color A.

2. A functional color changing camouflage as in claim 1 further wherein;
the focal length of said lens array is between 20 and 400 microns.

3. A functional color changing camouflage as in claim 1 further wherein;
said lens array has low reflectivity, low sheen, and or low gloss achieved by one of the following;
a microscopic surface roughness to diffract light, or
is made from of a polymer with inherent low reflectivity, low gloss, and or low sheen, or
is coated with a low reflectivity, low gloss, and or low sheen coating, or
contains a migratory additive(s) which bloom to the surface of the lens array creating light diffusion, reducing reflectivity, sheen and or gloss.

4. A functional color changing camouflage as in claim 1 further wherein;
said base layer consists of polymers with inherent outdoor weather resistance, such as polymethyl methacrylate, or
said base layer contains an ultraviolet blocker and or ultraviolet inhibiter enabling use of said camouflage for extended outdoor use.

5. A functional color changing camouflage as in claim 1 further wherein;
the number of colors each region shows when viewed through said first surface and viewing angle changes is more than two colors.

6. A functional color changing camouflage as in claim 1 further wherein,
said lens array is comprised of a material with wavelength bending characteristics such that said curvature of said lens array will change the direction of oncoming wavelengths of energy between 100 nanometers and 2000 nanometers, such that said oncoming wavelengths are predominantly scattered away from the source of said wavelength except for when the angle of incidence of said oncoming wavelengths is perpendicular to the planar surface of said lens array.

7. A functional color changing camouflage as in claim 1 further wherein;
said camouflage is used in the field by hunters, photographers, or military personnel to assist in preventing visible detection.

8. A functional color changing camouflage as in claim 1 further wherein;
said second surface of said base layer is combined with an adhesive to enable affixing to vehicle surfaces, aircraft, firearms, hunting blinds, and/or hunting equipment.

9. A functional color changing camouflage as in claim 1 further wherein;
said base layer is predominantly polycarbonate or similar bullet resistant transparent polymer.

10. A functional color changing camouflage as in claim 1 further wherein;
said colorized patterns are arranged in a frequency and alignment with said lens array such that when viewing through said lens array areas of individual colors appear to move up and down, or left and right, or at an angle when viewing angle changes.

11. A functional color changing camouflage as in claim 2 further wherein;
said base layer consists of polymers with inherent flexibility for adhering to compound curved surfaces.

12. A functional color changing camouflage as in claim 2 further wherein;
said camouflage is affixed to a woven material and stitched into clothing.

13. A functional color changing camouflage as in claim 1 further wherein;
said lens array has a melting point higher than a resin used for in-mold labeling process, such that when said functional camouflage is placed into a mold cavity and said resin is injected onto said second surface side of said base layer, the base layer will bond to said resin in molten form and said lens array will retain its optical characteristics and continue to reveal color changing effects as viewing angle changes.

14. A functional one-way see through color changing camouflage material comprising:
a substantially planar transparent base layer film with a lens array formed onto at least a substantial portion of a first surface of said base layer film, wherein said lens array contains lenses which are spaced apart by at least the diameter of said lens, and
colorized patterns are printed or formed onto the second surface of said base layer, wherein said colorized patterns are spaced apart by at least the diameter of said lenses and the frequency and alignment of said colorized patterns are in frequency and alignment with said lens array such that when viewed through said first surface and the viewing angle changes, areas showing predominantly color A change to predominantly color B, and areas showing predominantly color B change to predominantly color A, and
visibility through said second surface of said camouflage film is not substantially impaired.

15. A functional color changing camouflage as in claim 14 further wherein;
said second surface of said base layer is bonded to windows, or said base layer is a window on a vehicle, boat, aircraft, and/or hunting blind.

16. A functional one way see-through color changing camouflage as in claim 14, further wherein:
the windows are used on military vehicles.

17. A method of producing a functional color changing camouflage material comprising:
printing or forming a lens array onto at least a portion of a first surface of a substantially planar transparent base layer film, and
forming or printing colorized patterns onto the second surface of said base layer, wherein said colorized patterns are in frequency and alignment with said lens array such that when viewed through said first surface and viewing angle changes, areas showing predominantly color A change to predominantly color B, and areas showing predominantly color B change to predominantly color A.

18. A method of producing a functional color changing camouflage of claim 17 further wherein;
the thickness of said base layer is between 20 and 200 microns.

19. A method of producing a functional color changing camouflage of claim 17 further wherein;
said lens array consists of: linear, polygonal, Fresnel, or diffraction lens arrays.

20. A method of manufacturing a functional one-way see through color changing camouflage material comprising:
printing or forming a lens array formed onto at least a substantial portion of a first surface of a substantially planar transparent base layer,
wherein said lens array contains lenses which are spaced apart by at least the diameter of said lens, and
printing or forming colorized patterns onto the second surface of said base layer,
wherein said colorized patterns are spaced apart by at least the diameter of said lenses and the frequency and alignment of said colorized patterns are in frequency and alignment with said lens array such that when viewed through said first surface and the viewing angle changes, areas showing predominantly color A change to predominantly color B, and areas showing predominantly color B change to predominantly color A, and
visibility through said second surface of said camouflage is not substantially impaired.
